(19) United States
(12) Patent Application Publication
(10) Pub. No.: US 2021/0130032 A1
(43) Pub. Date: May 6, 2021

(54) FRESH-KEEPING PAPER BOX

(71) Applicant: NINGBO FRESHLY PACKAGING CO., LTD., NINGBO (CN)

(72) Inventor: Chengjun SHAN, Ningbo (CN)

(73) Assignee: NINGBO FRESHLY PACKAGING CO., LTD.

(21) Appl. No.: 16/819,155

(22) Filed: Mar. 15, 2020

(30) Foreign Application Priority Data
Oct. 30, 2019 (CN) 201911044507.6

(51) Int. Cl. B65D 3/06; B65D 65/40; B65D 3/14

(52) U.S. Cl. CPC B65D 3/06; B65D 3/14; B65D 65/40

(57) ABSTRACT

The present disclosure discloses a fresh-keeping paper box comprises a box body, and the box body is composed of a side wall spliced by a whole paperboard and a bottom wall formed by another trimmed paperboard; the bottom wall is pasted to the inner side wall of the side wall; an accommodating space for containing foods is formed inside the box body, and the accommodating space has an open upper end and a closed lower end, the technical scheme in this disclosure effectively solves the problem that airtightness of the existing paper box is influenced by joints inevitably occurred in its molding process, and the circumstance that multiple box bodies in overlaid packaging are difficult to separate due to airtightness is effectively prevented because of the bottom gap, thus makes it more convenient to use.

### CROSS-REFERENCE TO RELATED APPLICATIONS

This application claims priority to Chinese Patent Application No. 201911044507.6 with a filing date of Oct. 30, 2019. The content of the aforementioned application, including any intervening amendments thereto, are incorporated herein by reference.

### TECHNICAL FIELD

The present disclosure relates to the technical field of paper lunchboxes, in particular to a fresh-keeping paper box.

### BACKGROUND

With the development of the economy and quickening of pace of life, lunchboxes have been widely used in daily life, mainly serving as take-away packaging boxes and fresh-keeping utensils in refrigerators in supermarkets. The existing lunchboxes mainly can be divided into plastic lunchboxes and paper lunchboxes.

As for the plastic preservation box, benefited by the integrated molding structure and material features, its sealing property and flatness of the upper peripheral edge can be guaranteed, as well as the airtightness of the box laminated with a cover film when food packaging. However, the plastic preservation box, contrary to the concept of the prevailed sustained development due to its material non-renewal and high pollution, has become more and more obsolete. As a result, a paper preservation box emerges in the market to substitute for it.

At current, a paper lunchbox is mainly formed by mutually splicing or gluing one or more film paper into a square or round box body, adhering to a thin film layer inside the box body, and a cover film after putting foods into the box body. Theoretically speaking, the edges of the film paper are mutually spliced so there is no transition clearance, and further, the spliced portions are substantially same in thickness and any overlaying portion is avoided after the thin film layer is adhered to ensure equal thickness of each portion. Therefore, theoretical gaps are prevented because of mutual fit of the cover film and the thin film layer in the process of adhering to the cover film so as to ensure airtightness.

Meanwhile, the edges of the film paper are normally aligned directly, and a thin film layer is glued to realize the connection of aligned portions to meet the requirement of the airtightness. Whereas, it is obvious that as the side walls of the box body tend to expand outward, especially after foods are put in or the put-in foods are too heavy, the thin film layer bears large bilaterally-expanding force at the aligned joints, in this way, the film is easily damaged if it is under a long-term tensioned fatigue state, especially after placement for a long period of time, cracks invisible or visible to eyes occur at the joints to reduce the sealing property, in such a case, the freshness of foods cannot be kept due to invasion of bacteria into the lunchbox during the long-term storage process.

In addition, these paper lunchboxes are generally overlaid during packaging, which makes it difficult to separate each lunch box due to airtightness, therefore, it is inconvenient to take out the lunchbox when needed.

### SUMMARY

As far as the abovementioned problems in the prior art, the present disclosure provides a fresh-keeping paper box, which has the advantages of effectively solving the airtightness problem caused by inevitable joints of the paper box in molding, and being easy to overlay and separate, for overcoming the foregoing technical defects.

The specific technical solution is as follows:

A fresh-keeping paper box comprises a box body, and the box body is composed of a side wall spliced by a whole paperboard and a bottom wall formed by another trimmed paperboard; the bottom wall is pasted to the inner side wall of the side wall; an accommodating space for containing foods is formed inside the box body, and the accommodating space has an open upper end and a closed lower end.

The inner side wall of the accommodating space is also laminated with a thin film layer through suction plastic process or blowing plastic process, and the horizontal plane where the bottom wall is located is higher than the horizontal plane where the lowest end of the side wall is located to form a bottom gap of the box body.

Preferably, the side wall is formed by the enclosure of a whole paperboard of which two edges are overlaid and then pasted by glue or ultrasonic to form a seam line; the overlaid portion is twice as thick as the paperboard.

Preferably, the upper edge of the box body is also provided with a flanging formed by outward folding of the side wall.

Preferably, the outer fringe of the flanging is further folded once or more times to form a skirt border.

Preferably, the outer fringe of the bottom wall is folded downward to form a surrounding edge of which the outer wall is pasted to the inner side wall of the side wall.

Preferably, the lower edge of the side wall is folded inward to form a rib of which the inner wall is pasted to the inner wall of the surrounding edge.

Preferably, the bottom wall is rounded as a whole, and the side wall encloses the bottom wall for a circle.

Preferably, the bottom wall is also provided with at least a bleeder hole.

The abovementioned technical scheme produces the following beneficial effects:

The fresh-keeping paper box comprises a box body, and the box body is composed of a side wall and a bottom wall; a thin film layer is laminated inside the box body through suction or blowing plastic process so as to effectively solve the problem that airtightness of the existing paper box is influenced by joints inevitably occurred in its molding process; the circumstance that multiple box bodies in overlaid packaging are difficult to separate due to airtightness is effectively prevented because of the bottom gap, thus makes it more convenient to use.

### BRIEF DESCRIPTION OF THE DRAWINGS

FIG. 1 is a perspective view of a fresh-keeping paper box of the present disclosure;

FIG. 2 is a perspective view of the fresh-keeping paper box of the present disclosure, viewed from another angle;

FIG. 3 is a section view of the fresh-keeping paper box of the present disclosure;

FIG. 4 is a cross-section view showing overlaid portions of sheet parts on a flanging of the fresh-keeping paper box of the present disclosure.

### EMBODIMENTS

The technical means, creative features, objects and effects of the present disclosure will become more apparent from the following detailed description, which proceeds with reference to the accompanying figures.

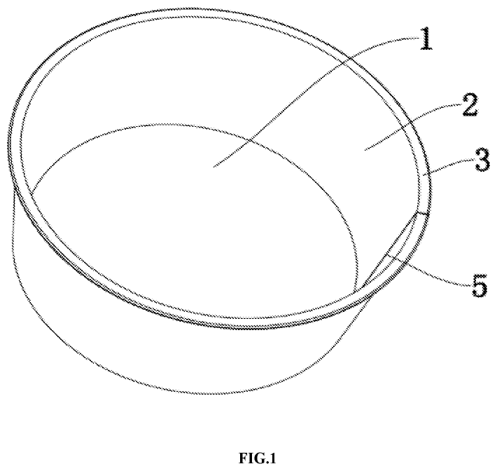

Referring to FIGS. 1-4, a fresh-keeping paper box provided by the present disclosure comprises a box body, and the box body is composed of a side wall 2 spliced by a whole paperboard and a bottom wall 1 formed by another trimmed paperboard; the bottom wall 1 is pasted to the inner side wall of the side wall 2 and an accommodating space for containing foods is formed inside the box body; the accommodating space has an open upper end and a closed lower end; the inner side wall of the accommodating space is also laminated with a thin film layer 6 through suction or blowing plastic process; and the horizontal plane where the bottom wall 1 is located is higher than the horizontal plane where the lowest end of the side wall 2 is located to form a bottom gap of the box body.

Based on the above technical scheme, the fresh-keeping paper box comprises a box body, and the box body is composed of a side wall 2 and a bottom wall 1; a thin film layer 6 is laminated inside the box body through suction or blowing plastic process so as to effectively solve the problem that airtightness of the existing paper box is influenced by joints inevitably occurred in its molding process; the circumstance that multiple box bodies in overlaid packaging are difficult to separate due to airtightness is effectively prevented because of the bottom gap, therefore, makes it more convenient to use. To be specific, a plurality of paper boxes in overlaid packaging are generally taken out in sequence from the underside by a sucking disc, as the bottom of the previous paper box clings to the inner bottom face of the next paper box, it's easy to take out two paper boxes at the same time when the sucking disc sucks up the next paper box from the below due to the airtightness, which is very inconvenient in use and this defect has been effectively overcome by the bottom gap of the present disclosure.

In a preferred embodiment, the upper edge of the box body is also provided with a flanging 3 formed by outward folding of the side wall 2 to enhance the strength of the side wall 2. Moreover, the outer fringe of the flanging 3 is further folded once or more times to form a skirt border 4, and the skirt border 4 may have a cross section of “-” shape formed by folding the flanging once, or a cross section of “hollow-square” shape formed by folding the flanging twice or more times, which is dependent on the dimension of the box body in production, thereby effectively enhancing the structure strength of the side wall 2.

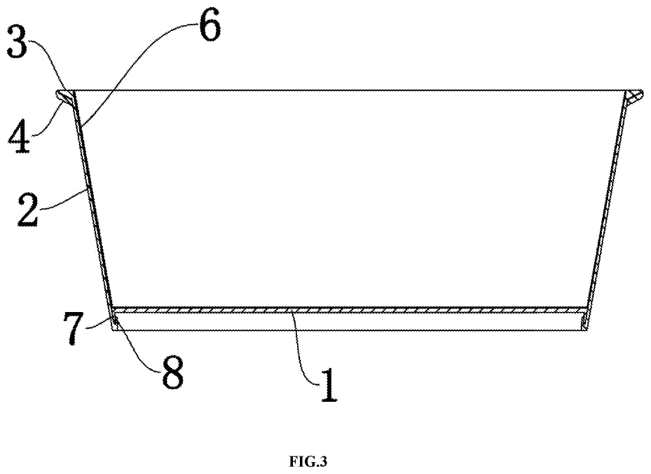

In a preferred embodiment, as shown in FIG. 3, the outer fringe of the bottom wall 1 is folded downward to form a surrounding edge 7, the outer wall of the surrounding edge 7 is pasted to the inner side wall of the side wall 2. Further, the lower edge of the side wall 2 is folded inward to form a rib 8, the inner wall of the rib 8 is pasted to the inner wall of the surrounding edge 7 so as to effectively enhance the installation strength of the bottom wall 1. The pasting mentioned above can be realized by glue or ultrasonic. Further, the bottom wall 1 is rounded as a whole, and the side wall 2 encloses the bottom wall 1 for a circle. It should be pointed out that the bottom wall 1 can also be selected from one of other polygonal structures or irregular shapes but is not limited thereto as long as the side wall 1 is enclosed into a corresponding shape. Further, the bottom wall 1 is also provided with at least a bleeder hole (not shown in the drawings).

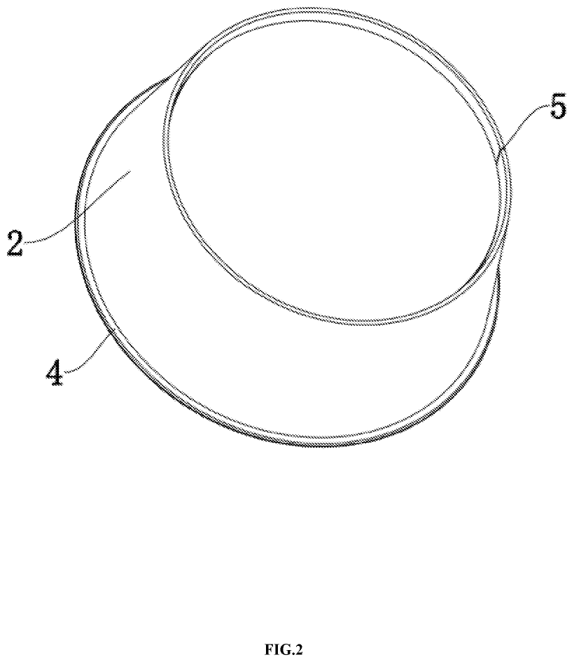

In a preferred embodiment, as shown in FIGS. 1 and 2, the side wall 2 is formed by the enclosure of a whole paperboard, and the two edges of the paperboard are overlaid and then pasted by glue or ultrasonic to form a seam line 5; the overlaid portion is twice as thick as the paperboard, which has better airtightness as compared to the existing method of aligning the edges of the paperboard directly and then gluing the edges by adhering to a thin film layer. As the paperboard is very thin, normal use of the paper box is not influenced by the thickness as much as two paperboards. When in specific use, foods are put inside the thin film layer, and a cover film 9 is further laminated to effectively prolong the fresh-keeping period of foods. Further, both the thin film layer 6 and the cover film 9 are made of EVOH, thus have high barrier property. Furthermore, when in specific use, foods and inert gas (preferably nitrogen) are stored in the accommodating space enclosed by the thin film layer 6 and the cover film 9 so as to effectively prolong the fresh-keeping period of foods. In the operation of pasting the cover film 9, foods can be stored in the accommodating space and air in the accommodating space is replaced with nitrogen, therefore, for one thing, a closed food accommodating space is formed between the thin film layer and the cover film, and for the other thing, air is replaced by inert gas so as to isolate the foods from oxygen, thus effectively prolonging its shelf life.

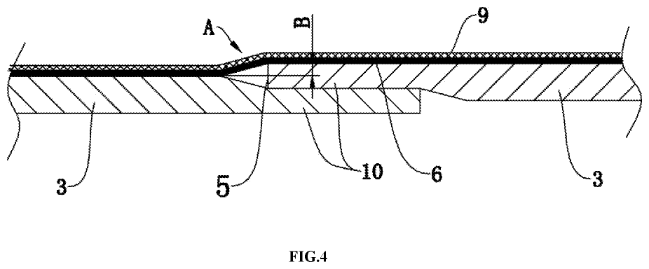

When in specific use, as shown in FIG. 4, the relative thickness is exaggerated in order to show the contents clearly; theoretically, relative to the prior art, the location along the seam line 5 especially on the flanging 3 is formed by overlaying two paperboards, and an overlaying portion 10 is formed. The overlaying portion (sheet parts) 10 is twice as thick as the paperboard by mutual press fit or glue gluing or ultrasonic bonding, especially a joint of a step structure (portion B in FIG. 4) is inevitably formed at the edge of the seam line 5 such that a fold (portion A in FIG. 4) is formed at this location after the thin film layer 6 is covered, and then the cover film 9 is adhered, and after mutual fit of the cover film 9 and the thin film layer 6, it may have poor sealing property at the fold.

However, in the actual production, a paperboard is often of 0.5 mm thick, while the step B formed by the overlaying portion 10 is also of 0.5 mm thick at most. In the processes of performing mould pressing molding of the box body and the suction or blowing plastic process, the step B is compressed to keep its thickness within 0.01 mm due to compressibility of the paperboard. At the same time, under the premise that the thin film layer 6 and the cover film 9 are thin enough (e.g., a conventional film is 0.03 mm thick), the abovementioned fold is relatively negligible, especially when the cover film 9 is also laminated at a device. The thin film layer 6 and the cover film 9 can be theoretically adhered into a whole by pressing fit and hot-melting methods so as to completely solve the problem that the two are incapable of complete sealing due to the fold. In addition, the step B can be further compressed in the pressing fit process. Shown by the specific production detection result of the technical scheme, airtightness at the fold can be ensured to reach the requirement, and the circumstance that the film is damaged in the long-term storage process in the prior art is avoided.

Furthermore, the above suction plastic process mainly comprises the following steps:

Step a, cutting out a bottom wall 1 and a side wall 2 from paperboards, splicing the paperboards to form a box body, putting the spliced box body into a suction plastic mould at a suction plastic station, tensioning a film roll material serving as a sheet above the box body, and heating and softening the film roll material by a heating component above the film roll material, preferably, the lower surface of the film roll material is provided with glue or the flanging 3 of the box body is coated with glue so that viscidity is better in a heated state;

Step b, performing the suction plastic operation on the film roll material by an air extractor at the suction plastic station through cracks of the paperboards invisible to eyes, so that the film roll material downward clings to the box body under the effect of the air extractor to form the thin film layer 6, the suction port of the air extractor can be disposed at arbitrary position outside the box body; and

Step c, carrying out hot-pressing or ultrasonic bonding on the peripheral fringe of the film glued to the edge.

The above merely provides the preferred embodiments of the present disclosure, which is illustrative, rather than restrictive, to the present disclosure. However, it should be understood by those skilled in the art that, many variations, modifications even substitutions that do not depart from the spirit and scope defined by the present disclosure, shall fall into the extent of protection of the present disclosure.

I claim:

1. A fresh-keeping paper box comprises a box body, wherein the box body is composed of a side wall spliced by a whole paperboard and a bottom wall formed by another trimmed paperboard; the bottom wall is pasted to the inner side wall of the side wall; an accommodating space for containing foods is formed inside the box body, and the accommodating space has an open upper end and a closed lower end; the inner side wall of the accommodating space is also laminated with a thin film layer through suction plastic process, and the horizontal plane where the bottom wall is located is higher than the horizontal plane where the lowest end of the side wall is located to form a bottom gap of the box body.

2. The fresh-keeping paper box of claim 1, wherein the side wall is formed by the enclosure of a whole paperboard of which two edges are overlaid and then pasted by glue or ultrasonic to form a seam line; the overlaid portion is twice as thick as the paperboard.

3. The fresh-keeping paper box of claim 2, wherein the upper edge of the box body is also provided with a flanging formed by outward folding of the side wall.

4. The fresh-keeping paper box of claim 3, wherein the outer fringe of the flanging is further folded once or more times to form a skirt border.

5. The fresh-keeping paper box of claim 1, wherein the outer fringe of the bottom wall is folded downward to form a surrounding edge of which the outer wall is pasted to the inner side wall of the side wall.

6. The fresh-keeping paper box of claim 5, wherein the lower edge of the side wall is folded inward to form a rib of which the inner wall is pasted to the inner wall of the surrounding edge.

7. The fresh-keeping paper box of claim 2, wherein the bottom wall is rounded as a whole, and the side wall encloses the bottom wall for a circle.

8. The fresh-keeping paper box of claim 1, wherein the bottom wall is also provided with at least a bleeder hole.

9. The fresh-keeping paper box of claim 1, wherein it further comprises a cover film, the said cover film is adhered to the upper surface of the box body and is pasted and integrated with the said thin film layer, foods and inert gas are stored in the storage space formed by the said thin film layer and the cover film.
